(19) United States
(12) Patent Application Publication
(10) Pub. No.: US 2019/0120514 A1
(43) Pub. Date: Apr. 25, 2019

(54) Wireless HVAC-R Sensor Probes and System

(71) Applicant: Fieldpiece Instruments, Inc., Orange, CA (US)

(72) Inventors: Jason Corbett Gilley, Orange, CA (US); Kennedy Srun Kong, Orange, CA (US)

(73) Assignee: Fieldpiece Instruments, Inc., Orange, CA (US)

(21) Appl. No.: 16/158,840

(22) Filed: Oct. 12, 2018

Related U.S. Application Data
(60) Provisional application No. 62/574,357, filed on Oct. 19, 2017.

(51) Int. Cl. F24F 11/30; F24F 11/52; F24F 11/56; G05B 19/048

(52) U.S. Cl. CPC F24F 11/30; F24F 11/52; F24F 2110/10; G05B 19/048; F24F 11/56

(57) ABSTRACT

HVAC-R sensor probes include a “visual indicator switch” that is built on to the tool itself. The switch can be toggled between 2 selections indicated by the colors red and blue. If the switch is on red, the color signifies high side pressure for a pressure gauge, high side temperature for a pipe clamp thermocouple, and return side for a psychrometer. If the switch is on blue, the color signifies low side pressure for a pressure gauge, low side temperature for a pipe clamp thermocouple, and supply side for a psychrometer. Once the switch has been set to the appropriate side, the probe will relay this information via wireless transmission to the smart device. The smart device reads this data in real time and will instantly set the tools to the selected side in the app, changing sides if the tool switch is once again toggled. This switch allows a direct correlation in the real world as well as in the virtual world.

This application in turn claims priority to U.S. Provisional Application 62/574,357, filed Oct. 19, 2017.

### FIELD OF THE INVENTIONS

The inventions described below relate to the field of diagnostic tools for heating, ventilation, air conditioning and refrigeration (HVAC-R).

### BACKGROUND OF THE INVENTIONS

HVAC-R technicians carry manifolds and other tools for diagnosing HVAC-R systems and checking the refrigerant level. With the advent of wireless technologies with suitable range, smart tool sensors can be used to relay information to a smart device. The smart device helps with interpreting the readings, and making the required calculations to check the HVAC-R system's health. There are several conventional wireless tools used with HVAC-R systems. However, these conventional wireless tools create potential problems and inefficiency. Conventional wireless sensors need to be configured correctly to measure the desired characteristic such as the “high side,” “low side,” “return side” or “supply side” before connection to the HVAC-R system, in order for the calculations and diagnostics of the smart device to be accurate. Improperly setting a sensor to measure one characteristic of the HVAC-R system can cause a misdiagnosis, which may result in unnecessary work and possibly a complete system replacement.

Several methods exist for assigning a wireless sensor to measure the desired HVAC-R system characteristic, the “side” of an HVAC-R system, in the smart device application software that interprets and displays the data from the wireless sensors. In one method, a user must match a multi-digit number from the wireless sensor to the assigned “side” in the application. Other methods include selecting and assigning a wirelessly linked sensor to a particular “side” or measured characteristic of the HVAC-R system. A colored sticker may then be applied to the wireless sensor to associate the sensor with the assigned HVAC-R system “side”, the high side (liquid line) or low side (suction line). Alternatively, the user can attach a colored battery cover, a cap or other suitable designator on the tool to distinguish which “side” of the HVAC-R system the designated tool is set to measure. Numerical or other stickers may also be used to distinguish several of the same type of tools connected on the system being evaluated.

Yet another method uses sensors that are designated to measure a single “side” or characteristic of the HVAC-R system from the factory. In order to have a pressure tool that measures the liquid line, a user must purchase the liquid line pressure tool. The same is true if a user would like a suction line pressure tool.

A user error may take many forms such as use of the wrong colored battery cover, assigning the wrong tool to the wrong side in the app, a coded sticker being misapplied or not having a functioning wireless sensor for a liquid line or other measurement. Such errors waste significant time and resources.

### SUMMARY

The devices and methods described below provide for an HVAC-R test system that incorporates one or more sensor probes that are wirelessly connected to any suitable smart device that is equipped with and running HVAC-R analysis software. Smart devices suitable for the test system may be any smart phone, cell phone, computer tablet, computer pad, personal digital assistant or portable computer capable of running a mobile app such as the HVAC-R analysis software.

The sensor probes in the new system include a switch assembly with a visual position indicator that is incorporated in the tool. The switch can be toggled between 2 positions indicated by different switch position indicators such as red and blue. If the switch position indicator is displaying red, the color signifies high side pressure for a pressure gauge, high side temperature for a pipe clamp thermocouple, and return side for a psychrometer. If the switch position indicator is displaying blue, the color signifies low side pressure for a pressure gauge, low side temperature for a pipe clamp thermocouple, and supply side for a psychrometer. Each switch position will enable the sensor probe to relay the switch position information via wireless transmission to the smart device where it is used by the software to interpret the data received from the probe sensors. If the tool switch position is changed, the visual indicator will alert the technician and the smart device software will interpret the received data according to the new switch setting.

Using the HVAC-R test system, technicians will spend less time fiddling with a smart device interface to assign a tool to a system side. It also eliminates the need to double check whether the tool is set to measure the correct system side or characteristic as shown in the smart device interface. The “visual indicator switch” identifies the system side setting to the user. The red and blue color indicators used in the smart sensor switch offer a contrasting view so that the technician can easily identify what system side the tool is set to measure, even from a distance. There is no need to rely on assigned/matching the tools based on serial numbers. User error is minimized and operating efficiency is optimized.

### BRIEF DESCRIPTION OF THE DRAWINGS

FIG. 1 is a block diagram of an HVAC-R sensor probe.

FIG. 2 is a block diagram of a wireless HVAC-R test system.

FIG. 3 is a top view of an HVAC-R pressure sensor.

FIG. 4 is a front view of the HVAC-R pressure sensor of FIG. 3.

FIG. 5 is a perspective view of the bottom/back of the HVAC-R pressure sensor of FIG. 3.

FIG. 6 is a back view of the HVAC-R pressure sensor of FIG. 3.

FIG. 7 is a perspective view of the HVAC-R pressure sensor of FIG. 3.

FIG. 8 is a perspective view of the front/bottom of the HVAC-R pressure sensor of FIG. 3.

FIG. 9 is a right side view of the HVAC-R pressure sensor of FIG. 3.

FIG. 10 is a left side view of the HVAC-R pressure sensor of FIG. 3.

FIG. 11 is an alternate perspective view of the HVAC-R pressure sensor of FIG. 3.

FIG. 12 is a bottom view of the HVAC-R pressure sensor of FIG. 3.

FIG. 13 is a back view of a pipe clamp thermocouple sensor.

FIG. 14 is a front view of the pipe clamp thermocouple sensor of FIG. 13.

FIG. 15 is an alternate back view of the pipe clamp thermocouple sensor of FIG. 13.

FIG. 16 is a side view of the pipe clamp thermocouple sensor of FIG. 13.

FIG. 17 is a front view of a psychrometer sensor.

FIG. 18 is a bottom/front perspective view of the psychrometer sensor of FIG. 17.

FIG. 19 is a bottom view of the psychrometer sensor of FIG. 17.

FIG. 20 is an illustration of a mobile device linked to a HVAC-R pressure sensor configured to measure the liquid side of an HVAC-R system.

FIG. 21 is an illustration of a mobile device linked to a HVAC-R pressure sensor configured to measure the suction side of an HVAC-R system.

FIG. 22 is an illustration of a mobile device linked to a HVAC-R temperature sensor configured to measure the high side of an HVAC-R system.

FIG. 23 is an illustration of a mobile device linked to a HVAC-R temperature sensor configured to measure the low side of an HVAC-R system.

FIG. 24 is an illustration of a mobile device linked to a HVAC-R psychrometer sensor configured to measure the return side of an HVAC-R system.

FIG. 25 is an illustration of a mobile device linked to a HVAC-R psychrometer sensor configured to measure the supply side of an HVAC-R system.

FIG. 26 is an illustration of the switch circuits for the Hall sensors of the selector switch assembly.

FIG. 27 is an illustration of the selector switch and designator element of the selection switch assembly for an HVAC-R pressure sensor in the high side position.

FIG. 28 is an illustration of the selector switch and designator element of the selection switch assembly for an HVAC-R pressure sensor in the low side position.

FIG. 29 is an illustration of the selector switch and designator element of the selection switch assembly for an HVAC-R pressure sensor in an intermediate position.

### DETAILED DESCRIPTION OF THE INVENTIONS

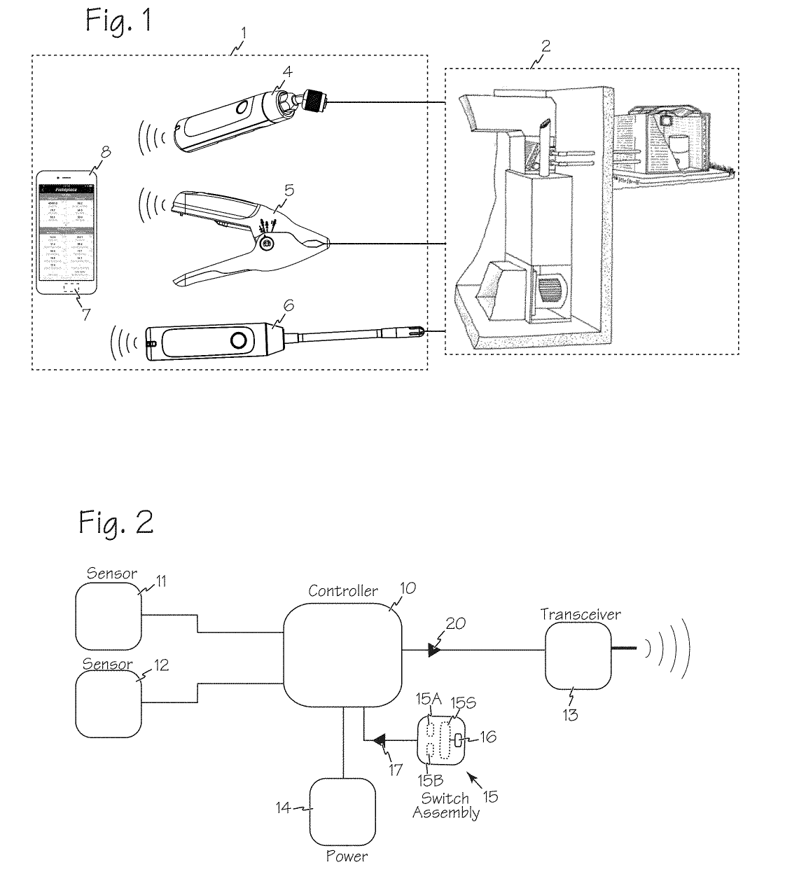

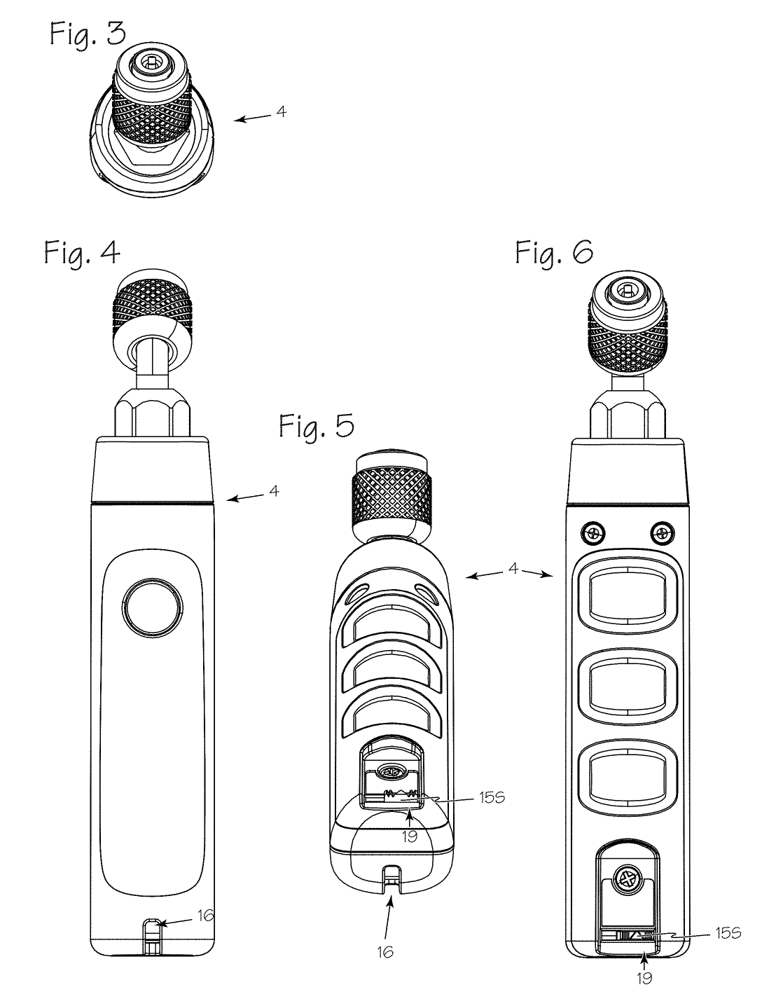

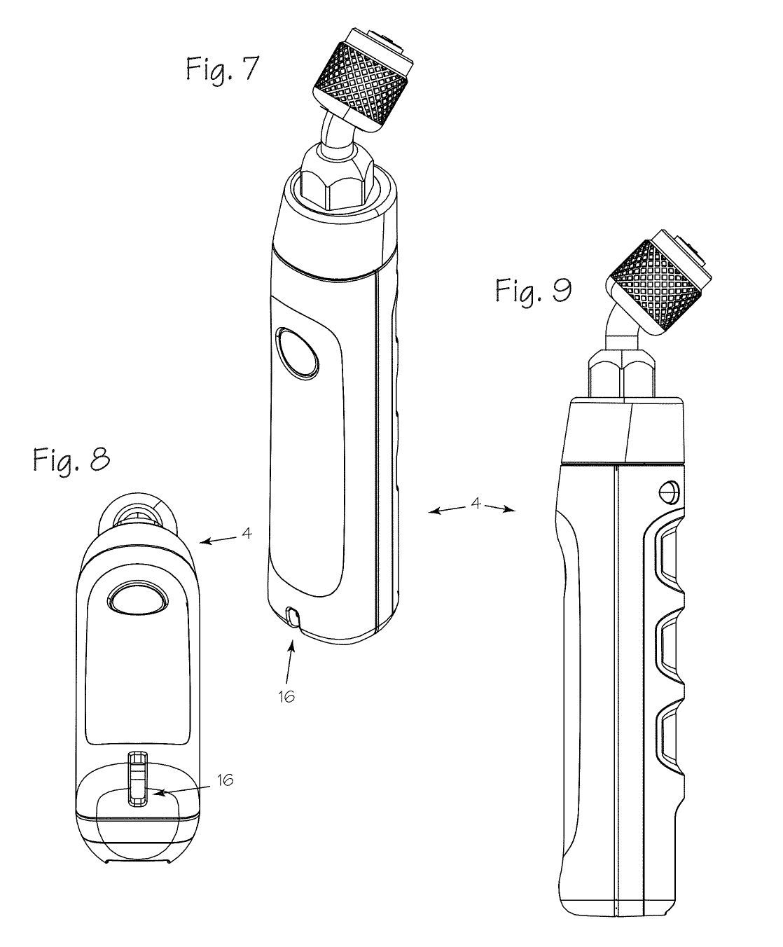

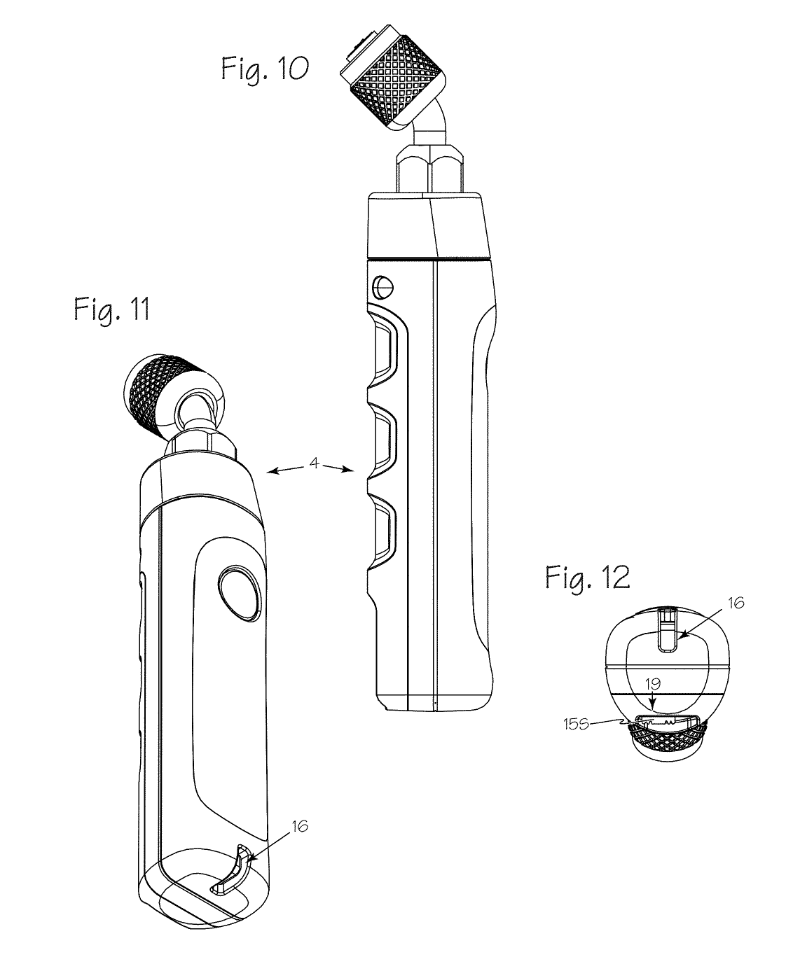

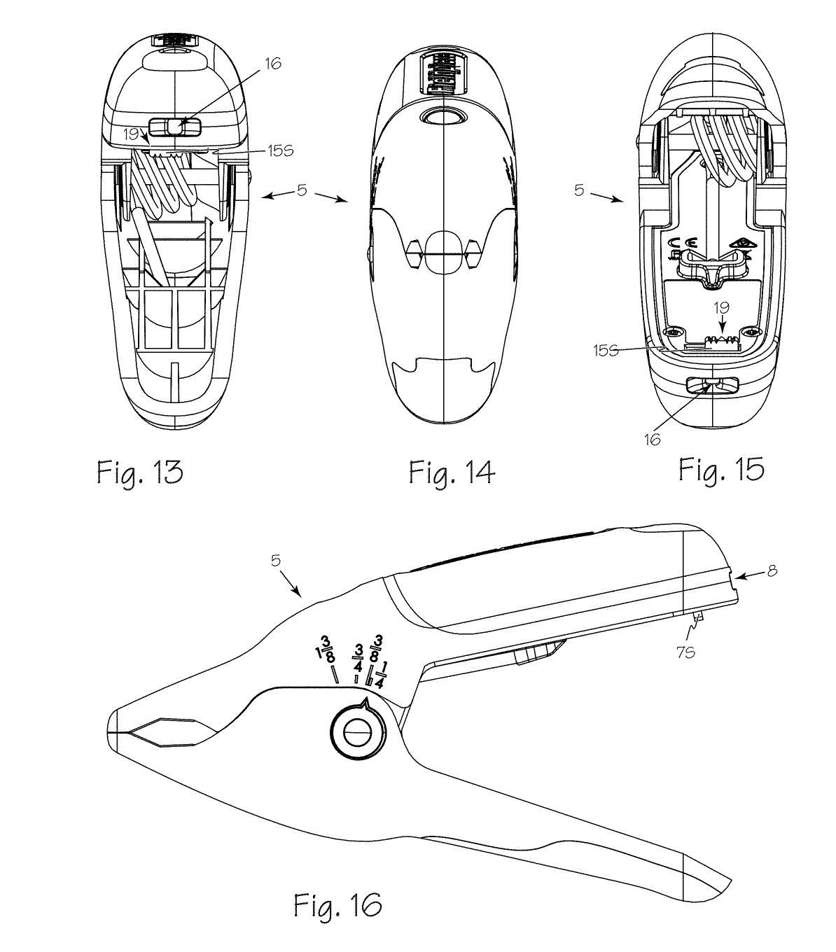

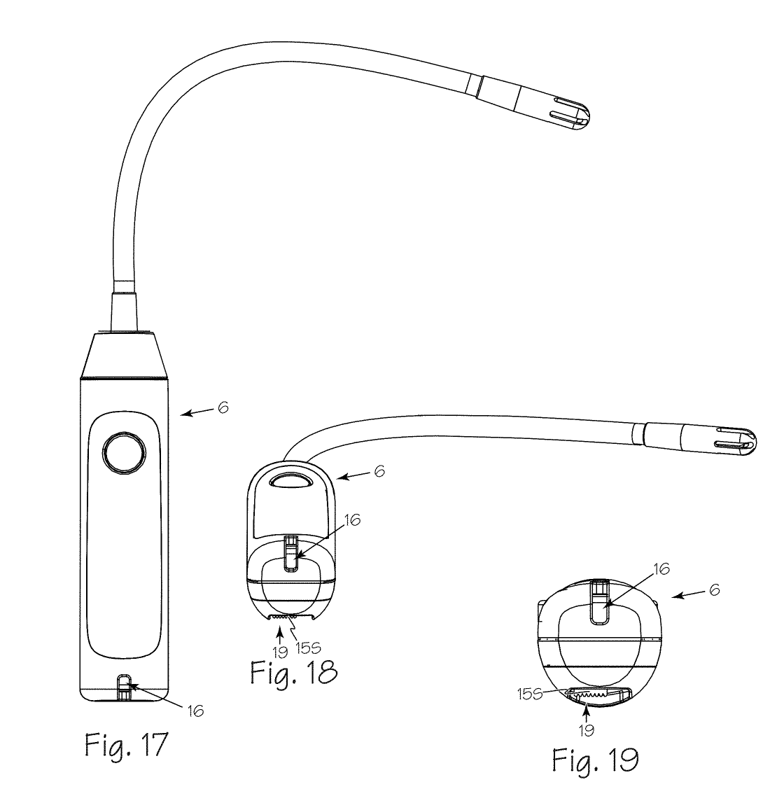

FIG. 1 is a block diagram of a wireless test system 1 for testing and adjusting a heating, ventilation, and air conditioning (HVAC-R) system 2. Wireless test system 1 includes one or more wireless sensor probes such as pressure sensor probe 4 as illustrated in FIGS. 3 through 12, pipe clamp thermocouple probe 5 as illustrated in FIGS. 13 through 16 and psychrometer sensor probe 6 as illustrated in FIGS. 17 through 19. The wireless sensor probes sense and measure any suitable HVAC-R characteristic such as temperature, pressure and relative humidity and are operatively connected to suitable elements of HVAC-R system 2 for testing and adjusting the HVAC-R system. Each of the wireless sensor probes are in wireless communication with HVAC-R analysis software 7 running on any suitable smart device such as smart device 8. HVAC-R analysis software analyzes data packets from the one or more wireless sensor probes and the software puts the data into a visual format for display to and action by a user working on the HVAC-R system.

FIG. 2 is a block diagram of the operating components of any of the wireless HVAC-R sensor probes of FIG. 1. The wireless sensor probes includes a controller 10, one or more HVAC-R sensors such as sensors 11 and 12, a wireless transceiver 13, a power source 14 and a selection switch assembly such as switch assembly 15. Sensors 11 and 12 may sense and measure any suitable HVAC-R characteristic such as temperature, pressure and relative humidity. Each switch assembly includes a selector switch 15S to change the operating range of the sensor probe. Each switch assembly also includes a designator element 16 that is visible from outside the sensor probes to provide a clear and unambiguous visual indication of the switch setting of the sensor probe. Any suitable pair of designators may be used to provide unambiguous distinction between the two available switch settings including numbers, letters, symbols and colors. For example, red may be used for one switch setting such as for high and blue may be used for the alternate switch setting such as for low.

The selection switch assembly 15 in the HVAC-R sensor probes incorporates one or more Hall effect sensors such as Hall effect sensors 15A and 15B to insulate the sensitive components on the sensor probes printed circuit board from outside influences while permitting the selector switch 15S to be toggled from outside the sensor probe. The selector switch 15S can be any suitable switch. The Hall effect sensor works by detection of a magnetic field of a magnet that is attached to the physical switch 15S. The switch status from the Hall effect sensor, switch status signal 17, is sent to the controller 10. A data value of 1 in signal 17 indicates that the switch is in a first position 18 which may be used for the low pressure, temperature and the supply side of the system. A data value of 0 indicates that the switch is in a second position 19 which may be used for the high pressure, temperature and the return side of the system. The sensor probes may optionally use 2 Hall sensors to prevent accidental triggers such as the switch being set to a center position or effects from any outside magnetic fields. With two Hall sensors switch status signal 17 will have 3 potential values, 10 11 and 01. The controller will assign a color (RED: 0 for combination 1,0 and BLUE: 1 for 0,1). If the controller receives signal 17 with a value 11 it will retain the last registered switch value.

TABLE 1

| | Red/High | Blue/Low | Center |
|---|---|---|---|
| Logic | 1 and 0 | 0 and 1 | 1 and 1 |
| Switch | 0 | 1 | Keep last Switch |
| Value | | | value |

The switch code is then incorporated into data packets such as data packet 20. Sensor probe data packets are formatted as shown in table 2. The data packets are transmitted by the transceiver 13 to any suitable smart device such as smart device 8 at a continuous intervals. Because of this continuous data transmission, the application software 7 on the smart device will interpret the switch value and indicate that the switch is in the appropriate position and will use the measured data according to the switch position.

TABLE 2

| 1 | 1 | 2 | 2 | 4 | 0.5 | 0.5 | 4 | 16 |
|---|---|---|---|---|---|---|---|---|
| Length | AD | Fieldpiece | Product | S/N | Switch | Battery | Calibration | Measured |
| | Type | Code | Code | | Value | Level | Date | Data |

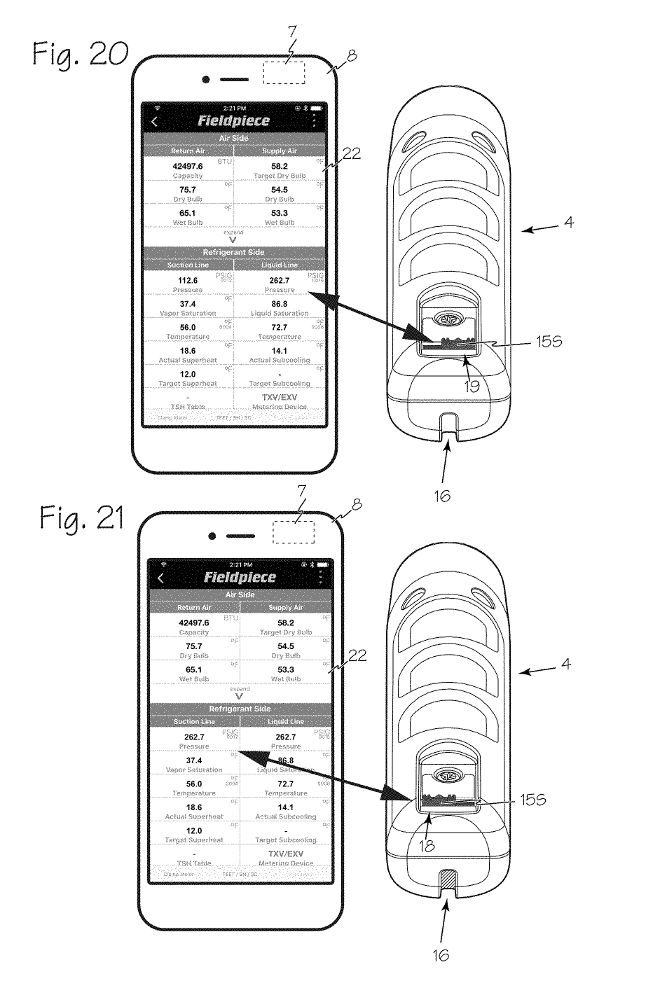

In operation, the wireless test system 1 has one or more wireless sensor probes such as pressure sensor probe 4, pipe clamp thermocouple 5 and or psychrometer probe 6 operatively connected to HVAC-R system 2. The one or more wireless sensor probes are also wirelessly connected to smart device 8 and they are transmitting data in data packets such as data packet 20 to the operating software 7 which is running on smart device 8. The operating software 7 interprets the HVAC-R system data and the sensor probe switch data from the one or more wirelessly connected sensor probes and presents the data as display 22, in FIGS. 20 through 25, for a user to view and take action to diagnose and or adjust HVAC-R system 2. The position of each selector switch 15S on the one or more wireless sensor probes will be incorporated in the data packets 20 that are received and interpreted by the operating software 7. The selector switch position data 17 is used by the operating software 7 to properly interpret the sensor data incorporated in data packets 20. The proper interpretation of the sensor data enables a user to correctly diagnose problems and to optimize operation of HVAC-R system 2.

FIGS. 3 through 12 illustrate pressure sensor probe 4 from various perspectives.

FIGS. 13 through 16 illustrate pipe clamp thermocouple probe 5 from various perspectives.

FIGS. 17 through 19 illustrate psychrometer sensor probe 6 from various perspectives.

FIG. 20 illustrates a smart device 8 linked to the HVAC-R pressure sensor 4 with selector switch 15S set to position 19 to measure the high or liquid side of an HVAC-R system. As discussed with respect to FIG. 2, switch data 17 which is incorporated in data packet 20 is used by HVAC-R analysis software 7 running on smart device 8 to produce data display 22 with the data from HVAC-R pressure sensor 4 analyzed and displayed for use by a user to correctly diagnose problems and to optimize operation of the HVAC-R system 2 of FIG. 2.

FIG. 21 illustrates a smart device 8 linked to the HVAC-R pressure sensor 4 with selector switch 15S set to position 18 to measure the low or suction side of an HVAC-R system. As discussed with respect to FIG. 2, switch data 17 which is incorporated in data packet 20 is used by HVAC-R analysis software 7 running on smart device 8 to produce data display 22 with the data from HVAC-R pressure sensor 4 analyzed and displayed for use by a user to correctly diagnose problems and to optimize operation of the HVAC-R system 2 of FIG. 2.

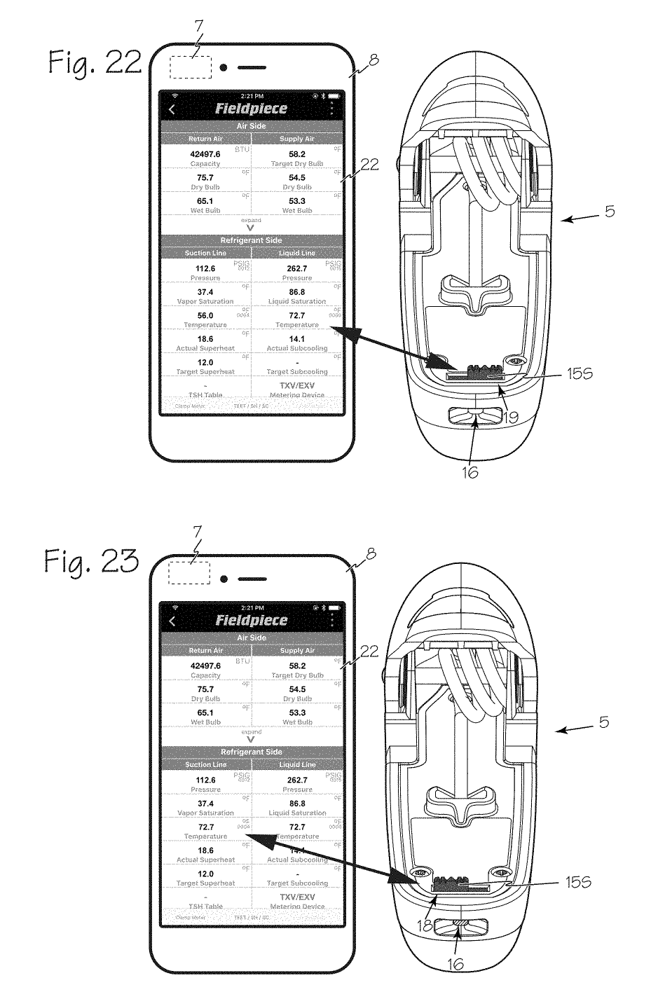

FIG. 22 illustrates a smart device 8 linked to the HVAC-R pipe clamp thermocouple 5 with selector switch 15S set to position 19 to measure the high or liquid side of an HVAC-R system. As discussed with respect to FIG. 2, switch data 17 which is incorporated in data packet 20 is used by HVAC-R analysis software 7 running on smart device 8 to produce data display 22 with the data from HVAC-R pressure sensor 4 analyzed and displayed for use by a user to correctly diagnose problems and to optimize operation of the HVAC-R system 2 of FIG. 2.

FIG. 23 illustrates a smart device 8 linked to the HVAC-R pipe clamp thermocouple 5 with selector switch 15S set to position 18 to measure the low or suction side of an HVAC-R system. As discussed with respect to FIG. 2, switch data 17 which is incorporated in data packet 20 is used by HVAC-R analysis software 7 running on smart device 8 to produce data display 22 with the data from HVAC-R pressure sensor 4 analyzed and displayed for use by a user to correctly diagnose problems and to optimize operation of the HVAC-R system 2 of FIG. 2.

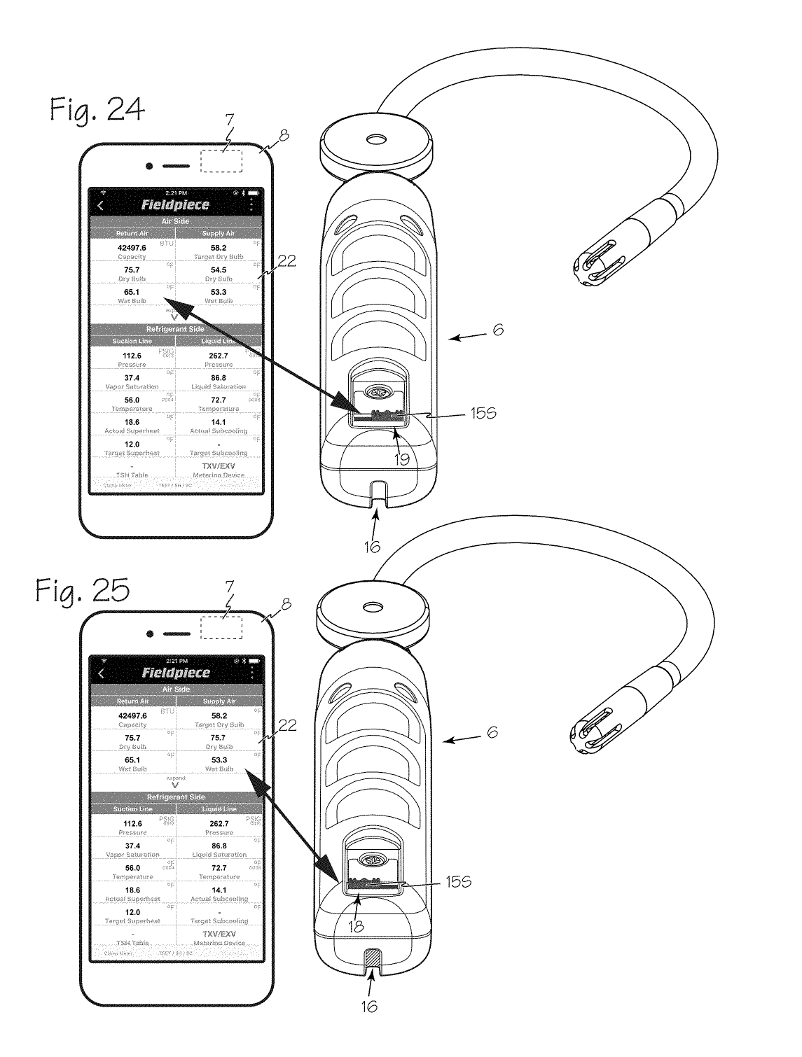

FIG. 24 illustrates a smart device 8 linked to the HVAC-R psychrometer sensor probe 6 with selector switch 15S set to position 19 to measure the high or liquid side of an HVAC-R system. As discussed with respect to FIG. 2, switch data 17 which is incorporated in data packet 20 is used by HVAC-R analysis software 7 running on smart device 8 to produce data display 22 with the data from HVAC-R pressure sensor 4 analyzed and displayed for use by a user to correctly diagnose problems and to optimize operation of the HVAC-R system 2 of FIG. 2.

FIG. 25 illustrates a smart device 8 linked to the HVAC-R psychrometer sensor probe 6 with selector switch 15S set to position 18 to measure the low or suction side of an HVAC-R system. As discussed with respect to FIG. 2, switch data 17 which is incorporated in data packet 20 is used by HVAC-R analysis software 7 running on smart device 8 to produce data display 22 with the data from HVAC-R pressure sensor 4 analyzed and displayed for use by a user to correctly diagnose problems and to optimize operation of the HVAC-R system 2 of FIG. 2.

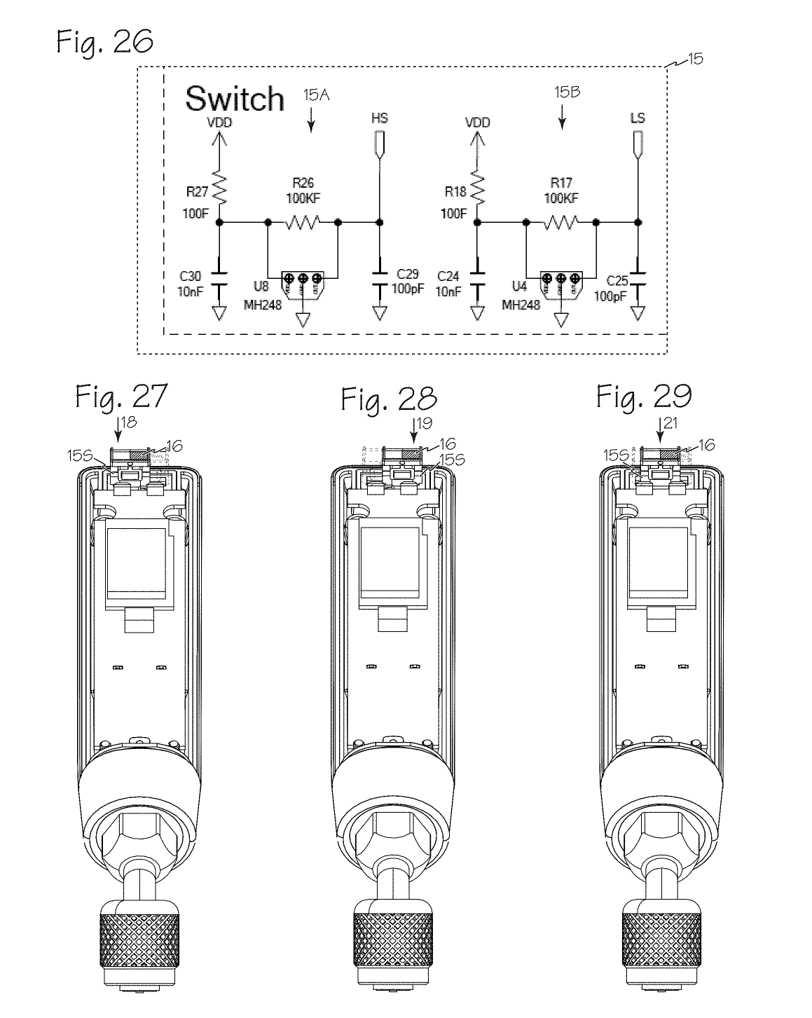

FIG. 26 illustrates the switch circuits for Hall sensors 15A and 15B of selector switch assembly 15.

FIG. 27 is an illustration of the selector switch 15S and designator element of the selection switch assembly 15 for an HVAC-R pressure sensor in the low side position 18.

FIG. 28 is an illustration of the selector switch 15S and designator element of the selection switch assembly 15 for an HVAC-R pressure sensor in the high side position 19.

FIG. 29 is an illustration of the selector switch and designator element of the selection switch assembly for an HVAC-R pressure sensor in an intermediate position 21.

While the preferred embodiments of the devices and methods have been described in reference to the environment in which they were developed, they are merely illustrative of the principles of the inventions. The elements of the various embodiments may be incorporated into each of the other species to obtain the benefits of those elements in combination with such other species, and the various beneficial features may be employed in embodiments alone or in combination with each other. Other embodiments and configurations may be devised without departing from the spirit of the inventions and the scope of the appended claims.

We claim:

1. An HVAC-R test system comprising:
one or more wireless sensor probes operable to collect data from an HVAC-R system;
a selection switch assembly in each of the one or more wireless sensor probes, the selection switch assembly including a selector switch operable to change the operating range of the wireless sensor probe and to generate switch data corresponding to the position of the selector switch;
a designator element incorporated into the selection switch assembly operable to provide a clear and unambiguous visual indication to a user of the position of the selector switch;
a controller for collecting the data and the switch data and creating data packets incorporating the data and switch data;
a smart device equipped with HVAC-R analysis software, wherein the smart device is operably connected to the one or more wireless sensor probes to transfer the data packets to the HVAC-R analysis software for display to and action by a user.
